(19) United States
(12) Patent Application Publication
(10) Pub. No.: US 2017/0293723 A1
(43) Pub. Date: Oct. 12, 2017

(54) TECHNIQUES FOR CENTRALLY MANAGING A CREDENTIALING LIFE CYCLE FOR HOSPITALS, PROVIDERS, INSURANCE PAYERS, CONTRACT MANAGEMENT, AND CLAIMS DATA PROCESSING ORGANIZATIONS

(71) Applicant: Scott T. Friesen, Lynbrook, NY (US)

(72) Inventor: Scott T. Friesen, Lynbrook, NY (US)

(21) Appl. No.: 15/483,462

(22) Filed: Apr. 10, 2017

Related U.S. Application Data
(60) Provisional application No. 62/319,940, filed on Apr. 8, 2016.

(51) Int. Cl. G06F 19/00; H04L 29/06

(52) U.S. Cl. CPC G06F 19/328; H04L 63/0428; H04L 67/42

(57) ABSTRACT

After realizing that few medical entities have ever viewed credentialing as an integral part of the revenue cycle, it becomes apparent why such medical entities have not viewed physician credentialing as an effective way to reduce administrative denials or as a way of generating incremental revenue. Given this realization, techniques disclosed herein improve computer operation to provide a systemic-level approach to medical revenue cycles. Exemplary aspects of the present disclosure identify where within the revenue cycle a medical entity is underperforming and what steps can be taken to rectify or remedy those underperforming areas. This identification process and subsequent remedies allow overall efficiencies of the medical entity to improve. Additional exemplary aspects of the present disclosure help eliminate redundant procedures that may occur at different points of the revenue cycle to increase efficiencies.

### PRIORITY CLAIM

The present application claims priority to U.S. Provisional Patent Application Ser. No. 62/319,94, filed on Apr. 8, 2016 and entitled “METHOD AND APPARATUS FOR CENTRALLY MANAGING THE CREDENTIALING LIFE CYCLE FOR HOSPITAL, PROVIDER, INSURANCE PAYER, CONTRACT MANAGEMENT, AND CLAIMS DATA PROCESSING ORGANIZATIONS,” the contents of which is incorporated herein by reference in its entirety.

### BACKGROUND

### I. Field of the Disclosure

The technology of the disclosure relates generally to improving computer operations to facilitate understanding of medical insurance metrics.

### II. Background

The relationship between medical care providers, administrators, and insurance payers may be described as a sometimes contentious, but ultimately symbiotic relationship. Medical care providers frequently rely on insurance payers for payment, but at the same time, medical care providers may resent the paperwork and drudgery required to be an approved medical provider within a particular insurance payer network. Such administrative hassles are resented and may contribute to less time available to provide care for patients as well as less revenue for healthcare entities. The passage of The Affordable Care Act (ACA) in March 2010 expands the number of people eligible for insurance coverage, in turn driving a renewed need for providers to be approved or enrolled with appropriate insurance payers. At the time of this filing, legislative efforts to repeal or modify the ACA have been defeated. Thus, it is likely that some form of the ACA with its increased enrollment opportunities as well as its focus on “fee-for-value” compensation schemes will be present for the near future.

While many providers may be individually altruistic and provide medical care for the love of the art, many of the institutions at which the medical providers practice their art are first and foremost businesses designed to turn a profit for their shareholders. While the Healthcare Financial Management Association (HFMA) has developed a standardized healthcare “revenue cycle” to assist in understanding the phases and processes involved in the healthcare revenue cycle, the cycle remains a complex process with numerous departments, hand-offs, and a dizzying combination of technology and human solutions. See generally FIG. 1.

To date, there is no solution which manages every aspect of the revenue cycle. While environments, processes, and software exist that assist medical providers in obtaining certification to admit patients to a healthcare organization, processes and robust software that pertain to the effective enrollment of healthcare providers with insurance carriers is lacking. Further, current processes and software do not address the entire physician enrollment life cycle from both a unified operational and financial perspective. Even where there are solutions for portions of the physician enrollment life cycle, these solutions are not necessarily positioned to provide output useful in the next stage of the cycle.

Further complicating the financial side of the healthcare landscape, the Centers for Medicare and Medicaid Services (United States insurance payer) has mandated the move from a fee-for-service to a fee-for-value reimbursement model by 2020. To accommodate the complete redesign of hospital and medical provider reimbursement, hospitals and medical providers have embarked on significant mergers and acquisitions between hospitals and physician practices. Each such event has implications for the revenue cycle as the newly acquired physicians must be credentialed with the hospital and then again with insurance payers in accordance with the hospital and national regulatory mandates. Absent such second-level credentialing, there may be a gap in services provided and the ability to collect fees for providing such services from insurance payers. This may result in hospitals and physicians finding that there is an increase in the number of physician-related denials, frustrated physicians, and lost revenue.

An additional wrinkle that has come from the ACA's fee-for-value reimbursement model combined with the mergers and acquisitions is the concept of a new reimbursement model called risk contracts or risk pools. Risk contracts seek to reduce and/or share the burden of expensive medical services between the insurance carrier and the medical provider and/or hospital. In its simplest iteration, an insurance carrier enters into a risk contract with a hospital or medical provider and offers to pay the hospital or medical provider a per patient, per year fee. In the event that the hospital or medical provider spends more money than the contracted per patient, per year fee, the hospital or medical provider absorbs the difference between the contracted per patient, per year fee and the actual cost of medical services (i.e., the overage). This can lead to substantial financial risk to both hospitals and medical providers. Alternatively, if the hospital or medical provider spends less on medical services than the contracted per patient, per year fee, the hospital or medical provider still receives the full contracted amount from the insurance carrier, which, in effect, rewards the hospital or medical provider for efficient, quality health care. Therefore, the insurance carrier, hospital, and medical provider share in the risk of providing medical services to their patients.

However, in addition to working in a penalty (hospital or medical provider absorbing the overage in medical services) or bonus (hospital or medical provider receives a bonus from the insurance carrier for spending less on medical services) risk contract, insurance carriers also mandate that they will only pay for medical services based on contracted service locations. In this additional risk-based scenario, insurance carriers will only pay hospitals or medical provider if they provide medical services at a contractually agreed to location or locations. In the event that a medical provider provides medical services to a patient outside of the agreed to locations, the insurance carrier has the right to refuse payment for any medical services provided by the medical provider at the non-agreed to locations. For example, if the medical provider has provider privileges at both locations, the medical provider may feel like he is allowed to see all patients at both locations. This also can lead to substantial financial loss for the hospital or medical provider.

Another wrinkle in risk-based contracting, is that insurance carriers may require a semi-frequent audit of all medical services provided and, in the event that the hospital or medical provider cannot provide data to substantiate that they are in accordance with the risk-based contracts (both in terms of where they wind up regarding spending more or less than the contracted per patient, per year fee and in terms of where they provide services), the hospital or medical providers may risk having to pay back a portion or, in some cases, all of the per patient, per year fees to the insurance carriers. This pay-back of fees can be financially catastrophic to a hospital or physician.

To date, no one has taken a holistic approach to the various activities and processes associated with the entirety of the revenue cycle (e.g., there are distinct entities that provide privileging credentialing investigative services and insurance enrollment credentialing investigative services and other entities that act as clearinghouses for claim submission). Even where an entity may provide solutions at multiple points along the revenue cycle (e.g., credentialing both for privileging and for insurance enrollment), that entity has treated such solutions as point or siloed solutions. Such point or siloed solutions lead to redundancies and inefficiencies within the revenue cycle. Further, such point and siloed solutions preclude the use of information to identify activities which have a negative impact on the revenue cycle.

### SUMMARY OF THE DISCLOSURE

Aspects disclosed in the detailed description include techniques for centrally managing a credentialing life cycle for hospitals, providers, insurance payers, contract management, and claims data processing organizations. After realizing that few medical entities have ever viewed credentialing as an integral part of the revenue cycle, it becomes apparent why such medical entities have not viewed physician credentialing as an effective way to reduce administrative denials or as a way of generating incremental revenue. Given this realization, exemplary aspects of the present disclosure provide techniques that improve computer operation to provide a systemic-level approach to medical revenue cycles. Exemplary aspects of the present disclosure identify where within the revenue cycle the medical entity is underperforming and what steps can be taken to rectify or remedy those underperforming areas. This identification process and subsequent remedies allows overall efficiencies of the medical entity to improve. Additional exemplary aspects of the present disclosure help eliminate redundant procedures that may occur at different points of the revenue cycle to increase efficiencies.

Still further, exemplary aspects of the present disclosure help identify in which risk groups a medical provider is authorized to operate based on real-time credentialing parameters and which activities fall outside treatment of such authorized risk groups. Based on this identification, revenue impacts of activities outside the treatment of the authorized risk groups may be evaluated and efforts made to encourage only authorized activities to maximize compensation under a fee-for-value insurance plan.

In this regard in one aspect, a method of communicating is disclosed. The method includes providing a computing platform accessible to a plurality of entities. The method also includes storing first data relating to an applicant's hospital credentialing application in memory associated with the computing platform. The method also includes storing second data relating to an applicant's enrollment with an insurance payer in the memory associated with the computing platform. The method also includes storing third data relating to an insurance payer's investigation of an applicant's enrollment application. The method also includes sharing at least some data from the first, second, and third data between entities involved in the applicant's hospital credentialing application, the applicant's enrollment, and the insurance payer's investigation.

In another aspect, a non-transitory computer-readable medium having stored thereon computer executable instructions. The instructions, when executed by a processor, cause the processor to provide access to memory associated with a computing platform accessible to a plurality of entities. The instructions also cause the processor to store first data relating to an applicant's hospital credentialing application in the memory associated with the computing platform. The instructions also cause the processor to store second data relating to an applicant's enrollment with an insurance payer in the memory associated with the computing platform. The instructions also cause the processor to store third data relating to an insurance payer's investigation of an applicant's enrollment application. The instructions also cause the processor to share at least some data from the first, second, and third data between entities involved in the applicant's hospital credentialing application, the applicant's enrollment, and the insurance payer's investigation.

In another aspect, a method of identifying out-of-contract activities is disclosed. The method includes receiving, at a cloud server, an appointment request from a patient. The method also includes determining, at the cloud server, if the appointment request complies with a risk contract. The method also includes allowing an appointment to be made based on the appointment request if the appointment request complies with the risk contract. The method also includes modifying the appointment to comply with the risk contract if the appointment does not comply with the risk contract.

### BRIEF DESCRIPTION OF THE FIGURES

FIG. 1 is the Healthcare Financial Management Association (HFMA) standardized healthcare revenue cycle;

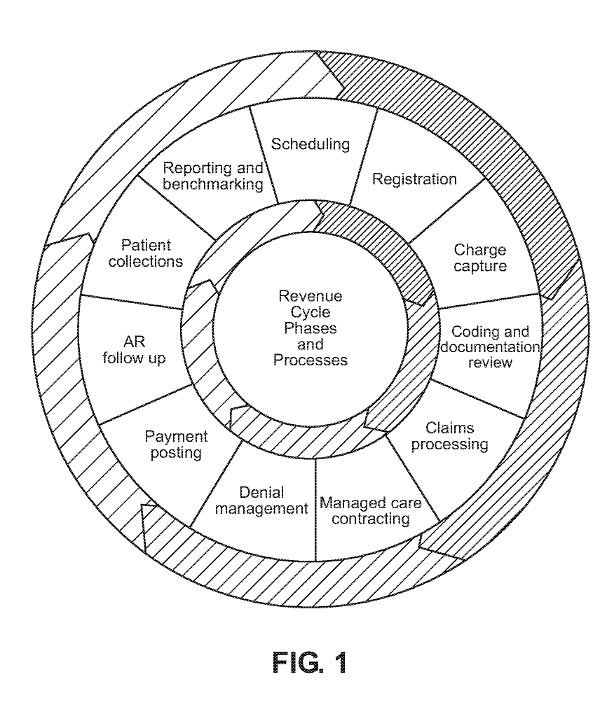

FIG. 2 illustrates a computer network for data entry and report generation according to exemplary embodiments of the present disclosure;

FIG. 3 illustrates a block diagram of a computing device;

FIG. 4 illustrates a hierarchical table of medical care entities;

FIG. 5 illustrates an exemplary cloud-computing system which may implement exemplary aspects of the present disclosure;

FIG. 6 is a flowchart of a process of using enterprise software according to exemplary aspects of the present disclosure; and

FIG. 7 is a block diagram illustrating information sharing between entities of a risk contract sharing system to assist risk contract management; and

FIG. 8 is a flowchart of risk contract management associated with the information sharing of FIG. 7.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

Aspects disclosed in the detailed description include techniques for centrally managing credentialing life cycle for hospitals, providers, insurance payers, contract management, and claims data processing organizations. After realizing that few medical entities have ever viewed credentialing as an integral part of the revenue cycle, it becomes apparent why such medical entities have not viewed physician credentialing as an effective way to reduce administrative denials or as a way of generating incremental revenue. Given this realization, exemplary aspects of the present disclosure provide techniques that improve computer operation to provide a systemic-level approach to medical revenue cycles. Exemplary aspects of the present disclosure identify where within the revenue cycle the medical entity is underperforming and what steps can be taken to rectify or remedy those underperforming areas. This identification process and subsequent remedies allows overall efficiencies of the medical entity to improve. Additional exemplary aspects of the present disclosure help eliminate redundant procedures that may occur at different points of the revenue cycle to increase efficiencies.

Still further, exemplary aspects of the present disclosure help identify in which risk groups a medical provider is authorized to operate based on real-time credentialing parameters and which activities fall outside treatment of such authorized risk groups. Based on this identification, revenue impacts of activities outside the treatment of the authorized risk groups may be evaluated and efforts made to encourage only authorized activities to maximize compensation under a fee-for-value insurance plan.

The revenue cycle is rife with inefficiencies and duplicative efforts. The interested reader is referred to the parent provisional patent application as well as some of the articles referenced therein for more information on the extent of the inefficiencies. Exemplary aspects of the present disclosure provide a unified approach to the credentialing process that improves computer efficiencies in tracking underperforming areas within the credentialing process. A net benefit of this unified approach is greater revenue opportunities for the medical entities implementing these techniques. One specific manner in which the unified, holistic approach to data sharing systems of the present disclosure assists in identifying revenue opportunities is through the use of tracking to which risk group a medical provider is authorized and identifying activities which fall outside treatment of the authorized risk group across the multiple participants/users of the platform across the credentialing life cycle. By identifying authorized versus unauthorized activities, the medical provider may change activities to operate within the treatment of the authorized risk group, thereby minimizing the likelihood that an insurance claim would be denied because of activities outside the treatment of the authorized risk group.

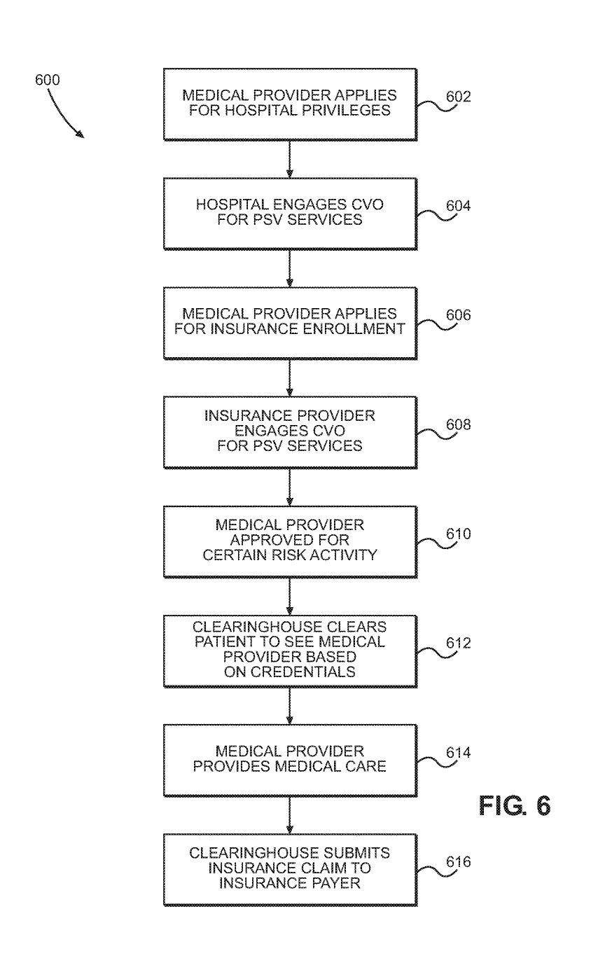

Before addressing specific aspects of the present disclosure, an overview of a computing system and the networks involved in the improved credentialing techniques are provided. Discussion of exemplary aspects of the present disclosure begins below with reference to FIG. 6.

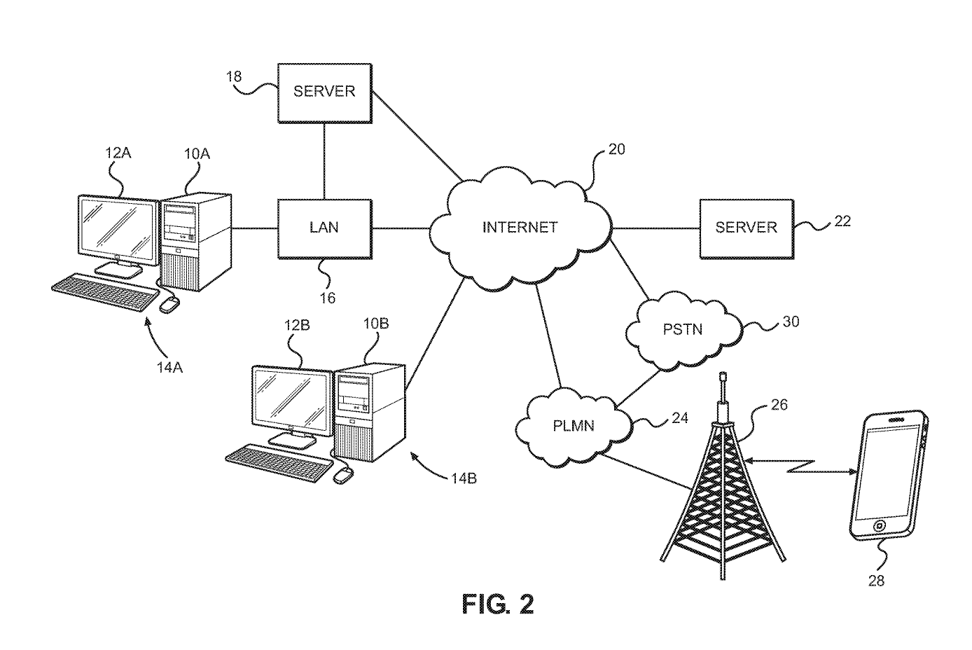

FIG. 2 illustrates a first user computer 10A with output display 12A and input elements 14A connected to a local area network (LAN) 16. A server 18 is also connected to the LAN 16. The LAN 16 and/or the server 18 may be connected to the internet 20. A second user computer 10B may be connected to the internet 20 directly (i.e., without an intervening LAN 16, but with appropriate communication links). The second user computer 10B may also include outputs 12B and inputs 14B. Collectively, or generically, user computers are referred to herein as user computers 10, output elements are referred to as outputs 12, and input elements are referred to as inputs 14.

It should be appreciated that the first user computer 10A and the server 18 may be co-located, located within a single building, single campus, or the like. Conversely, a server 22 may be positioned remotely from the user computers 10. Such a server 22 may enable remote computing solutions such as those sometimes referred to as “cloud computing”. That is, the software of the present disclosure may operate on a local computing device such as the user computers 10, or the local computing device may only have a client applet and the bulk of the computing activity takes place remotely, such as on the server 22. Additionally, the internet 20 may be connected to the Public Land Mobile Network (PLMN) 24, and communications between elements and a mobile terminal 28 may be effectuated, in part, through a base station 26. Additionally, or alternatively, the mobile terminal 28 may communicate through the Public Switched Telephone Network (PSTN) 30, through the internet 20 to other elements within the network. The mobile terminal 28 may be an example of one of the user computers 10 that allows a user to provide information and data according to embodiments of the present disclosure.

The mobile terminal 28 may be a smart phone such as the APPLE® IPHONE™. While the IPHONE™ is particularly contemplated, the disclosure is not so limited, and any readily portable handheld computing device may be appropriate, including personal digital assistants, cellular telephones, WINDOWS MOBILE™-enabled devices, tablet computers, or the like. Further examples of such mobile terminals include, but are not limited to: the BLACKBERRY™ line of wireless devices manufactured by Research in Motion of Waterloo, Ontario, Calif.; smartphones compatible with the ANDROID operating system as developed by GOOGLE, INC. of Mountain View, Calif.; mobile terminals manufactured by PALM, INC. of Sunnyvale, Calif.; and smartphones such as the WINDOWS® PHONE 7 or others compatible with operating systems designed by MICROSOFT® CORPORATION of Redmond, Wash. In other embodiments, a mobile terminal may comprise a portable personal computer with a sufficiently large, touch-sensitive screen (e.g., a “tablet” or “tablet computer” such as the APPLE® IPAD™, or a tablet-style computer compatible with the ANDROID operating system as developed by GOOGLE, INC.).

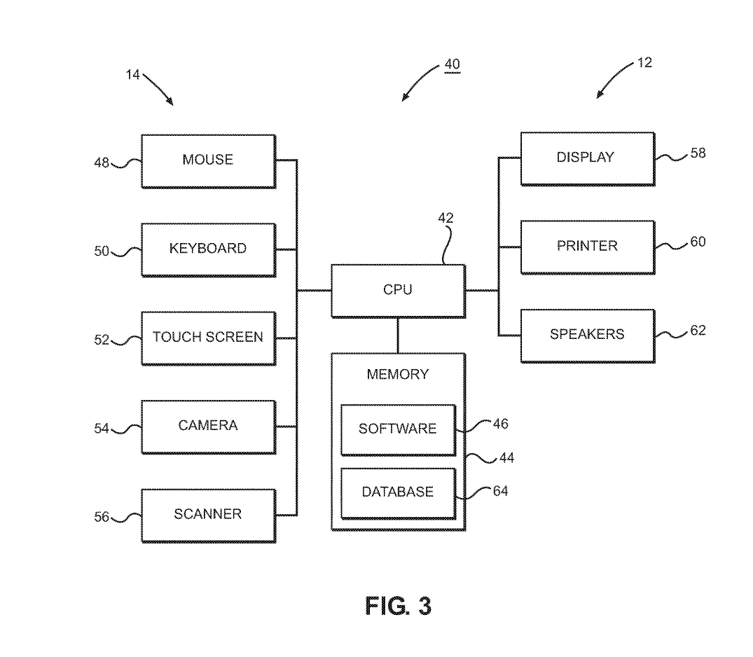

An exemplary computing device 40 is illustrated in block format in FIG. 3. As noted, the user computers 10, the servers 18 and 22, and the mobile terminal 28 may be computing device 40. The computing device 40 may include a central processing unit (CPU) 42 with associated memory 44 having software 46 stored thereon. Collectively the CPU 42, the memory 44, and the software 46 may form a control system as that term is defined in the Definitions section set forth below. The computing device 40 may further include input devices 14 such as a mouse 48, a keyboard 50, a touch screen 52 (or other display), a camera 54, a scanner 56, and/or similar input devices as is well understood. Further, the computing device 40 may further include output devices 12 such as a display 58, a printer 60, speakers 62, and/or similar output devices as is well understood.

Additionally, the computing device 40 may further include a database 64 within the memory 44. The database 64 may be integrated into the software 46 or provided separately as desired. Additionally, the database 64 may be remote from a particular computing device, but accessible therefrom. For example, one of the user computers 10 may access the database 64 on the server 22.

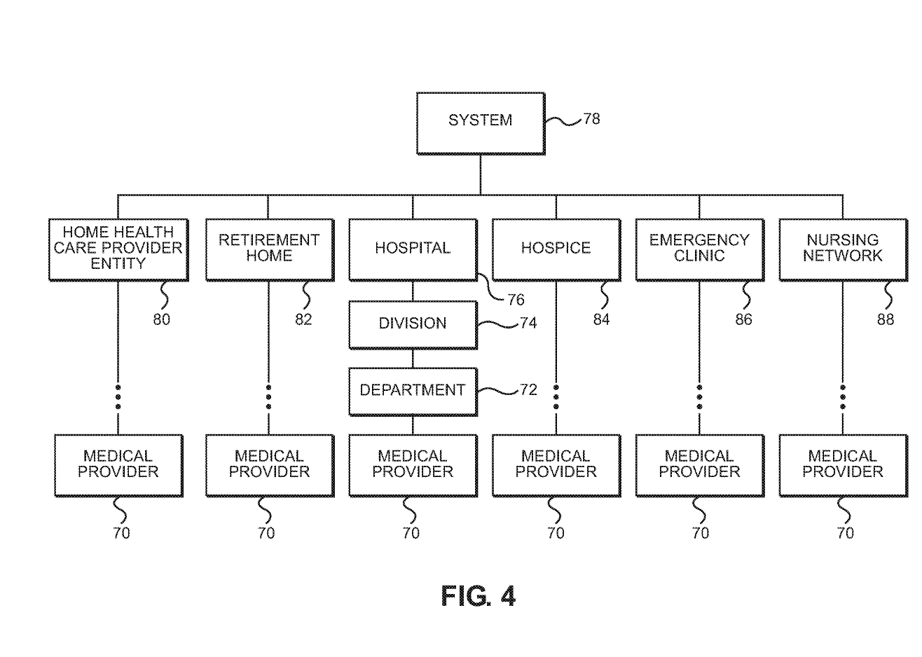

While FIGS. 2 and 3 illustrate some exemplary hardware on which the present disclosure may be implemented, FIG. 4 illustrates an exemplary hierarchy of medical care entities and terminologies. At the most atomic level, a medical provider 70 provides medical care to patients. As used herein, the term medical provider is defined to be someone with medical training who is authorized to provide medical services in a particular locale or jurisdiction. Exemplary medical providers include those holding a medical doctorate (MD), a doctorate of osteopathy (DO), a nurse practitioner (NP), a physician assistant (PA), a chiropractor, a certified mid-wife, and the like. One or more medical providers 70 may form a department 72. As used herein, the term department is defined to be a grouping of similar providers, providing multiple types of services related to a particular medical specialty. One or more departments 72 may form a division 74. As used herein, the term division is defined to be a grouping of similar providers, providing multiple types of services related to a particular medical specialty, but with increased levels of clinical specialization. An exemplary surgery division might have plastic surgery, facial reconstruction, cardiothoracic, and orthopedic departments. One or more divisions 74 may form a hospital 76. One or more hospitals 76 may form a medical system 78. The medical system 78 may also be an umbrella-style entity and have one or more additional sub-entities in its corporate or legal structure. Exemplary sub-entities may be a home health care provider entity 80, a retirement home 82, a hospice 84, an emergency clinic 86, a nursing network 88, or the like. Each sub-entity may have sub-sub-entities such as divisions, departments, and the like as is common in such structures. It should be appreciated that different medical systems 78 may have different compositions of sub-entities. For example, a first medical system 78 might be three hospitals 76 and a nursing network 88, and a second medical system 78 could be four retirement homes 82, a home health care provider entity 80 and a nursing network 88. Still other medical systems 78 are within the scope of the present disclosure. As used herein, the term medical entity is defined to be any one of a medical provider 70, a department 72, a division 74, a hospital 76, a medical system 78 or medical system sub-entity (e.g., hospice 84, home health care provider entity 80, etc.). Any of the medical entities defined herein may follow an Accountable Care Organization (ACO) model.

Further, as used herein the term “insurance payer” is defined to be a provider of health insurance. Note that a given payer may have a multiple subsidiaries or plans which may be aggregated as a single payer (e.g., Aetna HMO, Aetna PPO, Aetna Choice HMO, etc.). A health insurance policy is defined herein to be a contract between an insurance provider (e.g., an insurance company or a government) and an individual or her sponsor (e.g., an employer or a community organization). The contract can be renewable (e.g., annually, monthly) or lifelong in the case of private insurance, or may be mandatory for all citizens in the case of national plans. The type and amount of health care costs that will be covered by the health insurance provider are specified in writing, in a member contract, or “Evidence of Coverage” booklet for private insurance, or in a national health policy for public insurance.

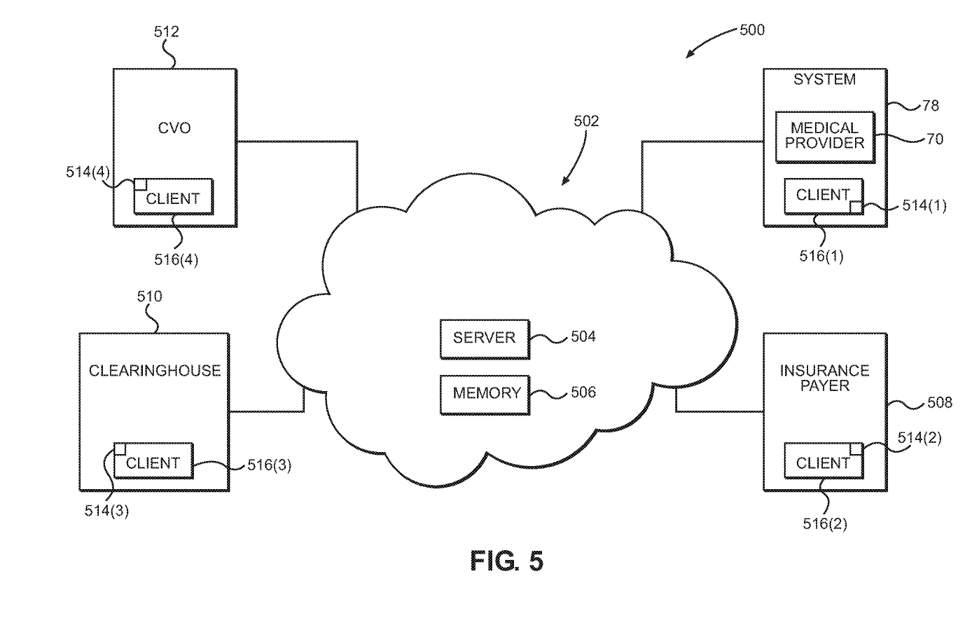

FIG. 5 provides a simplified block diagram of a cloud-computing network 500 that may be used with exemplary aspects of the present disclosure to interconnect various actors within the medical community. In particular, the “cloud” 502 has a cloud server 504 with associated memory 506. The various entities such as the medical system 78 of FIG. 4, an insurance payer 508, a clearinghouse 510, and a credential verification organization (CVO) 512 may couple to the cloud 502 through any communicative media such as the Internet, the PSTN, the PLMN, or the like. The cloud server 504 may host centralized software which communicates with client software 514(1)-514(4) on client devices 516(1)-516(4) at the respective entities.

By providing a centralized computing system accessible through the cloud 502, exemplary aspects of the present disclosure allow for sharing of information between the various entities to provide a unified system to assist in not only securing proper credentials for medical providers but also making sure that the credentials afforded to the medical provider match the services being provided by the medical providers.

Exemplary aspects of the present disclosure initially improve performance by consolidating the disparate processes into a single process that allows for intercommunication between entities and a commensurate reduction in redundancies while at the same time allowing bottlenecks or underperforming parts of the process to be more readily identified so as to allow remedial action. In this regard, FIG. 6 provides a flowchart of a process 600. The process 600 begins with a medical provider making an application for hospital privileges (block 602). While this is sometimes referred to as a credentialing process, the present disclosure refers to this as a hospital credentialing application or a privileging application. Note that the hospital may actually initiate the application as part of a merger or other activity. In an exemplary aspect, the medical provider may fill out a form that is hosted on the cloud server 504 and accessed through client software such as client software 514(1). The medical provider may further upload supporting documentation as needed or desired. Thus, the application and supporting documents may be stored in the associated memory 506 of the cloud server 504. This application may include various items about the medical provider's education, past work experience, and the like. When the hospital receives the completed application, the hospital engages a CVO to provide primary source verification (PSV) services (block 604). In an exemplary aspect, if the medical provider filled out the form and uploaded the supporting documents, the cloud server 504 merely makes this information available to the CVO and requests the PSV services. The CVO accesses the application and initial supporting documents and proceeds to verify the facts asserted therein. The findings of the PSV services are then uploaded back to the cloud server 504 and stored in the associated memory 506.

With continued reference to FIG. 6, the medical provider then applies for insurance enrollment (block 606). This application process is frequently referred to as a credentialing process, and it allows the medical provider to submit invoices to an insurance payer with confidence that the medical provider will be paid. The insurance payer frequently requires much of the same information that was provided to the hospital for the privileging application (hospital credentialing application). Again, this insurance enrollment application can be submitted to the cloud server 504 through an online form or the like. Again, supporting documents may be provided by uploading them. The cloud server 504 stores the application in the associated memory 506.

The insurance payer then engages a CVO (which may or may not be the same CVO as was engaged at block 604) to perform PSV services (block 608). The CVO may then access the application from the cloud server 504 and see that some of the PSV services have already been performed. Based on the reliability of the first CVO, the second CVO may accept that information as having already been verified or may perform its own verification processes. Again, because all the data is stored on the associated memory 506 of the cloud server 504, redundancies in information gathering are readily identified and duplicative work may be avoided.

Based on the findings of the CVO in the PSV services, the medical provider is approved certain risk activity (block 610). A patient may then approach the hospital or medical provider to receive certain medical care. As part of the intake process for that patient, the medical provider may submit patient information to the cloud server 504 with the instruction to pass the patient information to a clearinghouse so that the clearinghouse may clear the patient to see the medical provider based on the medical provider's credentialing (block 612). Thus, if the patient has a first type of insurance, but the medical provider is only enrolled with a second type of insurance, the clearinghouse may flag that patient for the medical provider as an ineligible patient. A recommendation for an affiliated medical provider may also be provided if needed or desired. Since the clearinghouse has access to the information on the cloud server 504, the clearinghouse knows or can ascertain whether the medical provider is enrolled with the patient's insurance provider. Likewise, the clearinghouse may find that the medical provider is non-participating with that insurance payer or that an application is in-process for enrollment. This alternate information may be provided to the medical provider and the medical provider may decide to treat the patient anyway.

If the medical provider is enrolled with the patient's insurance provider as indicated by the clearinghouse, the medical provider may provide the medical service for the patient (block 614). The medical provider then submits an insurance claim to the clearinghouse, and the clearinghouse scrubs the insurance claim for submission to the insurance payer (block 616).

It should be appreciated that almost every step in the process 600 may be broken down into further substeps. For example, collection of information for an application may have numerous items of information each of which must be performed independently. Likewise, the application must be signed and uploaded to the cloud server 504. The assignee of the present disclosure is also the owner of two patent applications which deal with the insurance credentialing process and the application preparation process. The interested reader is referred to U.S. patent application Ser. No. 13/294,645, filed Nov. 11, 2011, and Ser. No. 13/767,452, filed Feb. 14, 2013, which are hereby incorporated by reference in their entireties.

The present disclosure unifies those earlier efforts and adds to them the common cloud server 504 which allows other entities to participate in the process 600. Thus, the present disclosure allows the centralized cloud server 504 to track, trend, and link various workflow steps within a specific set of previously disconnected organizations or entities and organizes the workflows in an easy to use, cloud-based interoperable workflow management system. Additionally, exemplary aspects of the present disclosure enable the user to depict the financial impact of disconnected organizations and organizational workflows by linking charges to the “in-process” applications.

The process through which the data may be moved through the various workflow steps may occur by taking the steps required to process the data (e.g., the hospital PSV services and privileging, the provider enrollment process, the insurance payer credentialing, linking, tracking, and reporting to various risk based contracts, the contract management, and the clearinghouse services) and breaking them into organizationally specific workflows. Each representative organization may customize their workflow steps to meet their specific organizational processing requirements. However, within the organizational customized workflow, all steps are grounded in a single, cloud-based, interoperable platform which centrally stores and manages the data.

A representative example through which an organizational and/or enterprise workflow may be utilized may occur by enabling the organizational user to create work lists which organize, depict, track, age, and/or report on specific actions which need to be taken to resolve an account, application, etc. Specific organizations may develop organizational workflows independent of operational workflows of other participating organizations, and/or in conjunction with the operational workflows of the other participating organizations.

Representative examples of the types of functionality of the specific organization's operational workflows may include enabling a user to create work lists which mimic daily workflow of the specific organization. The work lists may be customized to mimic the daily workflow based on “Task Management,” or “Process Steps.” These process steps may be grounded in fixed operational steps (e.g., steps that must be taking according to industry or technology platform vendor requirements) but may also be supplemented with customized organizational process steps.

Some examples of the uses of the organizational customizable workflows include: a user may create customizable workflows pertaining to tasks within the credentialing life cycle, a user may create ticklers and/or reminders as to when they need to take a next follow-up action pertaining to an organizational workflow. This process may occur by aging out the time that particular PSV services or a particular provider enrollment application has been in process with a particular organization. Further, this process may occur by enabling the user to enter update notes, store update notes, and report on specific update notes which are linked to a particular organizational workflow. Further, this process may occur by enabling the user to report on activity codes chosen by a specific user, location, and/or organization. Further, this process may occur by enabling the user to transmit “requests for additional information” to a secondary user as it pertains to the follow-up needed to complete a particular application. Further, this process may occur by enabling the user to transfer an application to a supervisor for review as well as to enable the supervisor to transfer the application back to the user as it pertains to a particular application. Further, this process may occur by enabling the user to take multiple action steps at one time so as to increase follow-up efficiency. Further, this process may occur by enabling the user to run queries on particular workflow steps (at the enterprise or specific organizational level). Further, this process may occur, whereby a provider may check the status of their PSV services, enrollment application, or insurance PSV services, using easy to use, interactive, real-time dashboards. Finally, this process may occur by assigning heretofore unknown metrics to specific actions and activity codes pertaining to a particular application.

One such example of particular work lists can be found in the previously incorporated application, which focuses on the preparation and filing of the medical provider's credentialing application to the insurance payer.

Note that while the above discussion has focused on moving data between the disparate entities through the cloud, it should be appreciated that individual entities may mark some data as not being eligible for sharing. Such data may be protected by various privacy laws or contain some proprietary information that is inappropriate to share with other entities.

It has been noted that one of the side effects of consolidation in the medical industry is that certain medical systems 78 may have medical providers 70 that have initiated privileging applications for multiple locations within the medical system 78. For example, a doctor may apply to be authorized to work at ten different hospitals 76 within a medical system 78. Each privileging application may be distinct and may require additional effort to complete and submit. Still further, insurance payers may require additional credentialing applications for each location at which the doctor wishes to provide services. Again, each such credentialing application may require additional effort to complete and submit.

Insurance payers have also used what is sometimes referred to as risk contracts or risk groups. Such risk contracts define where certain patients may be treated and by which medical providers. These risk contracts may not align with subsequent changes in the medical system 78. For example, if a doctor is initially authorized by an insurance payer to treat patients at hospitals A-D, but the medical system 78 then merges and acquires hospitals E-H, the insurance payer may not automatically update the risk contract to allow the doctor to expect payment if the doctor treats patients at the new hospitals E-H. Exemplary aspects of the present disclosure allow for real time evaluations of how medical providers operate under such risk contracts and flag situations where activities may fall outside such risk contracts. This functionality is again enabled by sharing data across multiple historically siloed entities.

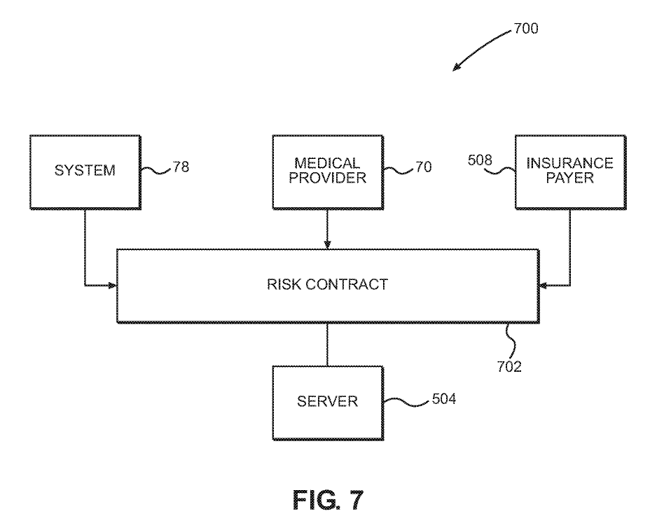

In this regard, FIG. 7 illustrates a conceptual risk contract sharing system 700. A risk contract 702 is shared between the medical system 78, the medical provider 70, and the insurance payer 508. The shared data may be stored on the cloud server 504. The cloud server 504 keeps the risk contract 702, and may compare at what locations within the medical system 78 the medical provider 70 is authorized to perform what services and be able to expect payment from the insurance payer 508. When an appointment is made for services that fall outside the approved risk group, an alert may be generated. Such alert may automatically prevent the appointment from being made, may change the appointment to occur at a facility at which the medical provider 70 is approved under the risk contract 702, or may change the medical provider 70 that provides the services to the patient to a medical provider that has the associated risk contract settings. In this manner, when the services are eventually provided and an insurance claim submitted to the insurance payer 508, the insurance claim conforms to the risk contract 702 and increases the likelihood that the insurance payer 508 pays the insurance claim. Further, by tracking what locations are authorized within the risk contract 702, entities may avoid privileging and credentialing applications for locations outside the risk contract 702.

In this regard, exemplary aspects of the present disclosure evaluate when an appointment is scheduled, and the cloud server 504 may route the appointment to a facility where the insurance payer 508 “prefers” to have the patient seen and/or where the medical provider 70 is certain that that facility where the patient will be seen will provide medical services which will fall below the contracted per patient, per year fee.

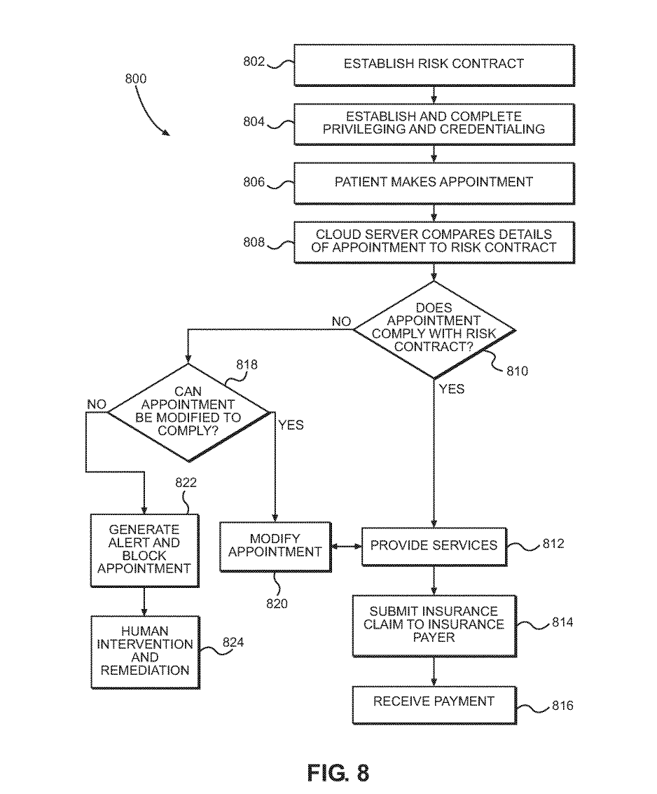

An exemplary process 800 illustrating risk contract management is provided with reference to FIG. 8. The process 800 begins with establishing the risk contract 702 (block 802) such as through a negotiation between the medical system 78 and the insurance payer 508. Privileging and credentialing requirements are then established for the risk contract 702, and the appropriate applications are filed and completed (block 804). Note that privileging and credentialing may exist for the risk contract 702 established based on existing privileges and credentials without departing from the scope of the present disclosure.

With continued reference to FIG. 8, a patient may make an appointment (block 806) for services with the medical system 78. The cloud server 504 compares the details of the appointment to the risk contract 702 (block 808) and determines if the appointment complies with the risk contract 702 (block 810). If the answer to block 810 is yes, the appointment complies, then the process 800 continues with the medical provider 70 providing the services (block 812). Subsequently, an insurance claim is submitted to the insurance payer 508 (block 814). The insurance payer 508 may compare the insurance claim to the risk contract 702, see that the insurance claim complies, and send payment such that the medical provider 70 receives payment (block 816).

Returning to block 810, if the answer is negative, an alert may be generated, and then the cloud server 504 determines if the appointment can be modified to comply (block 818). If the answer to block 818 is yes, the appointment is modified to comply (block 820). Such modification may include changing the location at which the services are provided, changing the medical provider 70, changing the type of the services (as appropriate), or the like. Once a compliant appointment is made, the process 800 may return to block 812 as previously discussed.

Returning to block 818, if the answer is no, the appointment cannot be readily modified, then an alert is generated and the appointment blocked (block 822). The alert causes human intervention, and remediation is provided (block 824). For example, the system may be overridden and the original appointment reinstituted, the patient may be contacted to arrange an alternate appointment with a medical provider authorized for a different risk group, or the like.

By sharing appointment information with the various entities in the risk contract sharing system 700, situations where payment would otherwise be declined are identified before the services are provided and transformed into compliant activities. This reduces the number of declined payments and increases services properly provided to the patients, which improves the health of the patients.

Those of skill in the art will further appreciate that the various illustrative logical blocks, modules, circuits, and algorithms described in connection with the aspects disclosed herein may be implemented as electronic hardware, instructions stored in memory or in another computer readable medium and executed by a processor or other processing device, or combinations of both. The devices described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

Against this backdrop of hardware including computer and network elements, exemplary aspects of the present disclosure are implemented thereon.

To assist in interpreting various elements within the specification and the appended claims, the present disclosure includes a terms and definitions section below. Where such terms are used in the claims, the definitions provided below replace any otherwise applicable meaning.

### Terms and Definitions

Numerous embodiments are described in this disclosure, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is neither a literal description of all embodiments nor a listing of features of the invention that must be present in all embodiments.

Neither the Title (set forth at the beginning of the first page of this disclosure) nor the Abstract (set forth at the end of this disclosure) is to be taken as limiting in any way as the scope of the disclosed invention(s).

Provider—May be defined as any medical specialty which provides clinical services. Providers may include MD, Dr. of Osteopathy, Nurse Practitioner, Physician Assistant, Certified Mid Wives, etc.

Provider Profile—The location where all individual provider information is stored and accessible for review or reporting.

Insurance Payer (Payer)—A provider of health insurance.

Credentialing—The process of conducting Primary Source Verification (PSV). This process includes validating data points (such as board certifications, employment history, medical license validation, etc.) to ensure that they are accurate, correct, and valid.

Enrollment—The process of enrolling a medical provider with an insurance plan. This process includes submitting an enrollment application to an insurance plan, having the insurance plan review and conduct PSV on the provider's enrollment application, and granting approval to that provider into the insurance plan's membership.

Clearinghouse—A vendor who receives claims data and processes or “scrubs” the data prior to submission to an insurance payer to ensure that the claims data has met all of the claims processing requirements of the insurance payers.

Primary Source Verification (PSV)—The process of validating data based on industry and governmental regulatory requirements.

Risk Based Contracting—The process of entering into a contract between the provider and insurance plan of offering increased financial payments based on the provider providing higher quality services and/or the provider receiving reduced financial payments based on the provider providing lower quality services based on agreed upon quality metrics between the provider and the insurance plan.

Participating (Par)—The process of formal recognition by a health insurance provider that a provider is “participating” with their health network.

Non-Participating (Non-Par)—The process of formal recognition by a health insurance provider that a provider is NOT “participating” with their health network.

In-Process—The formal process of applying to a health insurance provider to become “participating” with their health network.

Total Opportunity—The total number of PINs that a provider should have to be 100% participating. For example, 10 providers and 10 payers=100 PIN opportunities.

Days In Enrollment—DIE—The total number of days elapsed since the provider enrollment process was initiated as compared to a standardized metric.

Delegated Days In Enrollment—Delegated DIE—The total number of days elapsed since the provider enrollment process was initiated as compared to a standardized metric. A Delegated standardized metric may be 30 days.

Non-Delegated Days In Enrollment—Non-Delegated DIE—The total number of days elapsed since the provider enrollment process was initiated as compared to a standardized metric. A Non-Delegated standardized metric may be 180 days.

Days In Credentialing—DIC—The total number of elapsed days from when a provider is entered into the system to when the provider has been fully credentialed or a PSV has been completed.

Days In Privileging—DIP—The total number of elapsed days from when a provider has had their PSV completed to when the provider has been granted privileges to conduct clinical services.

Temporary Days In Privileging—TDIP—The total number of elapsed days from when a provider has had their PSV completed to when the provider has been granted temporary privileges to conduct clinical services.

Aging—The total number of days that have elapsed since the enrollment process was initiated.

Provider Identifier Number (PIN)—The unique identifier that a health insurance plan provides a provider in order to indicate that the provider has been accepted into the health insurance plan's network.

Effective Date—The date at which the PIN was granted and the provider has been accepted into the health insurance plan's network.

National Provider Identifier (NPI)—A unique identifier which is given by Medicare in order to track and trend a provider's billing activities as well as to indicate that the provider has been accepted into Medicare's network.

Healthcare Administrator—A manager of healthcare business office services.

Charges/Revenue/Gross Charges—The dollar amount that is charged by a provider or healthcare organization for services performed.

Financial Status Classification (FSC)—A method of depicting specific insurance payers and categories (e.g., Aetna HMO, Aetna PPO, Aetna Choice HMO, etc.).

Payer—A method of depicting a plethora of specific insurance payers and categories into one aggregated payer (e.g., e.g., Aetna HMO, Aetna PPO, Aetna Choice HMO=Aetna).

Reporting Category (RC)—A method of depicting a plethora of specific Payers into one aggregated reporting category (e.g., e.g., Aetna HMO, Aetna PPO, Aetna Choice HMO=Aetna—Aetna, Blue Cross, Cigna=Managed Care (reporting category)).

Provider Account—The master roll-up of all payers within a particular Provider's Account. Provider Account is the master roll-up. All insurance companies that are linked to that particular provider and need active follow-up will “roll up” into the Provider's Account.

Work list—A pre-determined and/or ad-hoc (real time) method of distributing accounts to be worked by a particular user.

Task—A particular action step(s) that needs to be taken in order to obtain a PIN.

Task-Based Work list—Creating a work list(s) based on the accumulation of specific tasks that need to be conducted in order to obtain a PIN.

Provider-Based Work list—Creating a work list(s) based managing all tasks related to obtaining a PIN for a particular provider.

Hybrid—Task- and Provider-Based Work list—Creating a work list(s) that entails creating a work list(s) which contain components of both a Task-Based Work list and a Provider-Based Work list.

CARElist—The software module which depicts workflow software pertaining to obtaining a PIN.

CAREreport—The software module which depicts reporting and analytics pertaining to provider enrollment. For more information, on a CAREreport, the interested reader is directed to U.S. patent application Ser. No. 13/767,452, filed Feb. 14, 2013, which is hereby incorporated by reference in its entirety.

CAREdemographics—The software module which depicts the demographic data required to obtaining a PIN.

CAREscan—The software module which allows a user to scan documents into the system and auto-populate fields on the PDF.

CARE—The Comprehensive provider enrollment software module which contains specific software modules including CARElist, CAREreport, CAREdemographics, CAREscan, etc. All modules or specific modules may be used at one time.

Demographics—The section in the software where all demographic data is entered and stored.

Productivity Reports—A pre-determined and/or ad-hoc (real time) method of depicting actions taken by a particular user.

Activity Code/Step—A particular code and/or unique identifier which is linked to a particular activity that a particular user takes.

Tickler—A pre-determined and/or user defined reminder that a particular action needs to be taken.

Tickle Timeframe—A pre-determined and/or user defined amount of time that a user may assign between one follow up date to the next.

Request For Information (RFI)—A tool which enables a user to electronically request additional information from a third party.

Navigation Bar (Nay Bar)—A tool which enables the user to easily navigate throughout the software platform. This will apply to both the WMS and CAREreport.

Payer Bar—A dynamic and real time method of depicting and sorting follow up activities related to a provider. Payer Bar may be sorted by:
a. Most recent tickle timeframe (e.g., account may have a follow up action taken today)
b. Greatest Charge (by provider, or by payer)
c. A combination of most recent tickle timeframe and greatest charge (e.g., tickle time frame of Jan. 1, 2012 with a total payer charge amount of $500,000)

Payer Block—A depiction of a particular payer that has providers who have follow-up actions that may be taken. All payers may be listed as individual Payer Blocks and listed in the Payer Bar.

Future Follow-Up—All accounts which require a follow-up action due today or in the future.

Cross Payor—The ability to assign a follow-up action across multiple payers at one time.

Cross Location—The ability to assign a follow-up action across multiple payers at one time.

Follow-Up Screen—A screen which contains all applicable data elements, actions steps, and history associated with a particular provider and a particular payer.

Action Code/Steps—A number of pre-formatted actions that may be taken and recorded in order to complete a provider's enrollment.

Credentialing Receivables—Outstanding in-process applications that have an associated charge with them.

Credentialing In Process (CIP)—The total number of PIN Opportunities that exist within a database and/or work list. For example, an administrator uploads 1,000 providers into the WMS and creates 10 different work lists, split by alpha. Of the 10 work lists with 100 PIN Opportunities, there exist a total of 1,000 CIP. Each time a PIN has been obtained for a particular provider and is associated with a particular payer, the PIN Opportunity goes down and the CIP has been worked.

Credentialing In Process (CIP) $—The total dollars associated with the total number of PIN Opportunities.

Credentialing In Process (CIP) #—The total number of PIN Opportunities that need to be worked in order to obtain a PIN.

Credentialing In Process (CIP) Department—The total number of PIN Opportunities for all providers, which are rolled up into specific departments. Credentialing In Process (CIP) Payer—The total number of PIN Opportunities for all providers, which are rolled up into specific payers.

The terms “a”, “an” and “the” mean “one or more”, unless expressly specified otherwise.

The term “plurality” means “two or more”, unless expressly specified otherwise.

The term “herein” means “in the present disclosure, including anything which may be incorporated by reference”, unless expressly specified otherwise.

The phrase “at least one of”, when such phrase modifies a plurality of things (such as an enumerated list of things) means any combination of one or more of those things, unless expressly specified otherwise. For example, the phrase at least one of a widget, a car and a wheel means either (i) a widget, (ii) a car, (iii) a wheel, (iv) a widget and a car, (v) a widget and a wheel, (vi) a car and a wheel, or (vii) a widget, a car and a wheel.

The phrase “based on” does not mean “based only on”, unless expressly specified otherwise. In other words, the phrase “based on” describes both “based only on” and “based at least on”.

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

Each process (whether called a method, algorithm or otherwise) inherently includes one or more steps, and therefore all references to a “step” or “steps” of a process have an inherent antecedent basis in the mere recitation of the term ‘process’ or a like term. Accordingly, any reference in a claim to a ‘step’ or ‘steps’ of a process has sufficient antecedent basis.

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device or article is described herein, more than one device or article (whether or not they cooperate) may alternatively be used in place of the single device or article that is described. Accordingly, the functionality that is described as being possessed by a device may alternatively be possessed by more than one device or article (whether or not they cooperate).

Similarly, where more than one device or article is described herein (whether or not they cooperate), a single device or article may alternatively be used in place of the more than one device or article that is described. For example, a plurality of computer-based devices may be substituted with a single computer-based device. Accordingly, the various functionality that is described as being possessed by more than one device or article may alternatively be possessed by a single device or article.

The functionality and/or the features of a single device that is described may be alternatively embodied by one or more other devices that are described but are not explicitly described as having such functionality and/or features. Thus, other embodiments need not include the described device itself, but rather can include the one or more other devices which would, in those other embodiments, have such functionality/features.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine may not transmit data to the other machine for weeks at a time. In addition, devices that are in communication with each other may communicate directly or indirectly through one or more intermediaries.

A description of an embodiment with several components or features does not imply that all or even any of such components and/or features are required. On the contrary, a variety of optional components are described to illustrate the wide variety of possible embodiments of the present disclosure. Unless otherwise specified explicitly, no component and/or feature is essential or required.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

Although a process may be described as including a plurality of steps, that does not indicate that all or even any of the steps are essential or required. Various other embodiments within the scope of the described invention(s) include other processes that omit some or all of the described steps. Unless otherwise specified explicitly, no step is essential or required.

Although a product may be described as including a plurality of components, aspects, qualities, characteristics and/or features, that does not indicate that all of the plurality are essential or required. Various other embodiments within the scope of the described invention(s) include other products that omit some or all of the described plurality.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, a PDA” does not imply that any or all of the three items of that list are mutually exclusive and does not imply that any or all of the three items of that list are comprehensive of any category.

Headings of sections provided in this disclosure are for convenience only, and are not to be taken as limiting the disclosure in any way.

“Determining” something can be performed in a variety of manners and therefore the term “determining” (and like terms) includes calculating, computing, deriving, looking up (e.g., in a table, database or data structure), ascertaining, recognizing, and the like.

The computers and servers described herein may have a display. A “display” as that term is used herein is an area that conveys information to a viewer. The information may be dynamic, in which case, an LCD, LED, CRT, LDP, rear projection, front projection, or the like may be used to form the display. The aspect ratio of the display may be 4:3, 16:9, or the like. Furthermore, the resolution of the display may be any appropriate resolution such as 480i, 480p, 720p, 1080i, 1080p or the like. The format of information sent to the display may be any appropriate format such as standard definition (SDTV), enhanced definition (EDTV), high definition (HD), or the like. The information may likewise be static, in which case, painted glass may be used to form the display. Note that static information may be presented on a display capable of displaying dynamic information if desired.

The computers and servers described herein may have a control system. A “control system”, as that term is used herein, may be a computer processor coupled with an operating system, device drivers, and appropriate programs (collectively “software”) with instructions to provide the functionality described for the control system. The software is stored in an associated memory device (sometimes referred to as a computer readable medium). While it is contemplated that an appropriately programmed general purpose computer or computing device may be used, it is also contemplated that hard-wired circuitry or custom hardware (e.g., an application specific integrated circuit (ASIC)) may be used in place of, or in combination with, software instructions for implementation of the processes of various embodiments. Thus, embodiments are not limited to any specific combination of hardware and software.

A “processor” means any one or more microprocessors, CPU devices, computing devices, microcontrollers, digital signal processors, or like devices. Exemplary processors are the INTEL PENTIUM™ CORE or comparable AMD ATHLON processors or the like.

The term “computer-readable medium” refers to any medium that participates in providing data (e.g., instructions) that may be read by a computer, a processor or a like device. Such a medium may take many forms, including but not limited to, non-volatile media, volatile media, and transmission media. Non-volatile media include, for example, optical or magnetic disks and other persistent memory. Volatile media include DRAM, which typically constitutes the main memory. Transmission media include coaxial cables, copper wire and fiber optics, including the wires that comprise a system bus coupled to the processor. Transmission media may convey acoustic waves, light waves and electromagnetic emissions, such as those generated during RF and IR data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, a USB memory stick, a dongle, any other memory chip or cartridge, a carrier wave, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols. For a more exhaustive list of protocols, the term “network” is defined below and includes many exemplary protocols that are also applicable here.

It will be readily apparent that the various methods and algorithms described herein may be implemented by a control system and/or the instructions of the software may be designed to carry out the processes of the present disclosure.

As used herein a “network” is an environment wherein one or more computing devices may communicate with one another. Such devices may communicate directly or indirectly, via a wired or wireless medium such as the Internet, Local Area Network (LAN), Wide Area Network (WAN), or Ethernet (or IEEE 802.3), Token Ring, or via any appropriate communications means or combination of communications means. Exemplary protocols include but are not limited to: BLUETOOTH™, TDMA, CDMA, GSM, EDGE, GPRS, WCDMA, AMPS, D-AMPS, IEEE 802.11 (WI-FI), IEEE 802.3, TCP/IP, or the like. Note that if video signals or large files are being sent over the network, a broadband network may be used to alleviate delays associated with the transfer of such large files, however, such is not strictly required. Each of the devices is adapted to communicate on such a communication means. Any number and type of machines may be in communication via the network. Where the network is the Internet, communications over the Internet may be through a website maintained by a computer on a remote server or over an online data network including commercial online service providers, bulletin board systems, and the like. In yet other embodiments, the devices may communicate with one another over RF, cellular networks, cable TV, satellite links, and the like. Where appropriate encryption or other security measures such as logins and passwords may be provided to protect proprietary or confidential information.

Communication among computers and devices may be encrypted to insure privacy and prevent fraud in any of a variety of ways well known in the art. Appropriate cryptographic protocols for bolstering system security are described in Schneier, APPLIED CRYPTOGRAPHY, PROTOCOLS, ALGORITHMS, AND SOURCE CODE IN C, John Wiley & Sons, Inc. 2d ed., 1996, which is incorporated by reference in its entirety.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A method of communicating comprising:
providing a computing platform accessible to a plurality of entities;
storing first data relating to an applicant's hospital credentialing application in memory associated with the computing platform;
storing second data relating to an applicant's enrollment with an insurance payer in the memory associated with the computing platform;
storing third data relating to an insurance payer's investigation of an applicant's enrollment application; and
sharing at least some data from the first, second, and third data between entities involved in the applicant's hospital credentialing application, the applicant's enrollment, and the insurance payer's investigation.

2. The method of claim 1, wherein providing the computing platform comprises providing a cloud-based server with associated memory and network connections to the plurality of entities.

3. The method of claim 1, wherein storing the first data comprises storing primary source verification (PSV) data.

4. The method of claim 3, wherein storing the third data comprises storing second PSV data.

5. The method of claim 4, wherein sharing the at least some data comprises sharing the PSV data with the second PSV data.

6. The method of claim 1, further comprising encrypting communications with the plurality of entities.

7. The method of claim 1, further comprising associating application cost data with the applicant's hospital credentialing application.

8. The method of claim 1, further comprising associating enrollment cost data with the applicant's enrollment with the insurance payer.

9. The method of claim 1, wherein at least one of the plurality of entities comprises an entity selected from the group consisting of a medical provider, a hospital, an insurance payer, a claims clearinghouse and a physician.

10. The method of claim 1, further comprising tracking to which risk entity a medical provider is assigned.

11. A non-transitory computer-readable medium having stored thereon computer executable instructions which, when executed by a processor, cause the processor to:
provide access to memory associated with a computing platform accessible to a plurality of entities;
store first data relating to an applicant's hospital credentialing application in the memory associated with the computing platform;
store second data relating to an applicant's enrollment with an insurance payer in the memory associated with the computing platform;
store third data relating to an insurance payer's investigation of an applicant's enrollment application; and
share at least some data from the first, second, and third data between entities involved in the applicant's hospital credentialing application, the applicant's enrollment, and the insurance payer's investigation.

12. The non-transitory computer-readable medium of claim 11, wherein the computer executable instructions further cause the processor to store the first data comprising primary source verification (PSV) data.

13. The non-transitory computer-readable medium of claim 12, wherein the computer executable instructions further cause the processor to store the third data comprising second PSV data.

14. The non-transitory computer-readable medium of claim 13, wherein the computer executable instructions further cause the processor to share the PSV data with the second PSV data.

15. The non-transitory computer-readable medium of claim 11, wherein the computer executable instructions further cause the processor to encrypt communications with the plurality of entities.

16. The non-transitory computer-readable medium of claim 11, wherein the computer executable instructions further cause the processor to track to which risk entity a medical provider is assigned.

17. The non-transitory computer-readable medium of claim 16, wherein the computer executable instructions further cause the processor to assign a risk contract to the medical provider.

18. The non-transitory computer-readable medium of claim 16, wherein the computer executable instructions further cause the processor to reconcile payment of clinical services based on the risk contract.

19. A method of identifying out-of-contract activities, comprising:
Receiving, at a cloud server, an appointment request from a patient;
determining, at the cloud server, if the appointment request complies with a risk contract;
allowing an appointment to be made based on the appointment request if the appointment request complies with the risk contract; and
modifying the appointment to comply with the risk contract if the appointment does not comply with the risk contract.

20. The method of claim 19, further comprising determining if the appointment can be modified to comply with the risk contract and generating an alert if the appointment cannot be modified.

21. The method of claim 19, further comprising generating an alert if the appointment does not comply with the risk contract.
